(19) United States
(12) Patent Application Publication
(10) Pub. No.: US 2010/0151093 A1
(43) Pub. Date: Jun. 17, 2010

(54) Food forming and cooking apparatus and associated method

(76) Inventor: Peter J. Wilk, New York, NY (US)

Correspondence Address: R. Neil Sudol, 714 Colorado Avenue, Bridgeport, CT, 06605-1601, US

(21) Appl. No.: 10/851,823

(22) Filed: May 21, 2004

Related U.S. Application Data
(60) Provisional application No. 60/472,853, filed on May 23, 2003.
(60) Provisional application No. 60/480,105, filed on Jun. 20, 2003.

(51) Int. Cl. A21D 6/00; A21C 9/06; A21C 9/08

(52) U.S. Cl. 426/281; 426/501; 426/498; 99/450.6; 99/443 R

(57) ABSTRACT

In a method for manufacturing a food product, a closed dough preform is formed having an arcuate portion that is at least partially hollow. The dough preform is cooked to form a comestible item having an internal chamber in the arcuate portion. The preform has an internal space that is closed off from communication with the ambient atmosphere so that the preform has no openings or holes in an external surface that communicate with the internal space or hollow interior of the preform. An apparatus for carrying out the method includes a transport mechanism moving the dough preforms from an assembly line to a heating device.

### BACKGROUND OF THE INVENTION

This invention relates to an apparatus and to an associated method for preparing a finished food product. More particularly, this invention relates to an apparatus and to an associated method for cooking discrete food articles such as bagels.

The tastiest parts of certain baked food products such as muffins and bagels are those that are browned owing to exposure to an oven's convection currents. In eating muffins, people frequently separate the crowns from the bodies of the muffins in order to savor the enhanced flavor of the crowns. Likewise, in eating bagels, some people characteristically remove the inner, doughy parts of the bagel and eat only the shell, either alone or with filling such as a cream cheese and scallion spread or a salmon spread. Where a bagel is used to make a sandwich type food item, the hollowing out of the bagel provides the additional advantage of reducing the amount of filling that is squeezed out from between the bagel halves when the consumer bites into the bagel. Concomitantly, a hollow bagel is able to accommodate a greater amount of filling material.

A problem with the conventional manual method of removing dough from the interior of a bagel is inconvenience to the consumer. Another problem is waste that occurs when the removed interior dough is discarded rather than eaten.

Although certain food products such as doughnuts are frequently made with hollow interiors, into which a cream or fruit filling may be deposited, the method by which that hollow interior is formed is not applicable to bagels. Doughnuts can be made from dough that separates during deep-frying to produce an interior chamber. Bagels are cooked by an initial boiling step and a subsequent baking step. Bagels with hollow interiors will not naturally form during the two-step cooking process.

U.S. Pat. No. 5,807,599 describes a method for making a food product that utilizes an aliquot of dough disposed in a predetermined shape about a cooking member made of a material which has a chemical composition essentially impervious to cooking temperatures. The dough is cooked, e.g., boiled or baked, at a predetermined temperature for a predetermined period. The cooking member is maintained in the dough during the cooking thereof. After the cooking of the dough at the predetermined temperature for the predetermined period, the cooking member is removed from the cooked dough, thereby creating a chamber in the cooked dough.

Generally, as described in U.S. Pat. No. 5,807,599, the dough is molded about the cooking member to form the predetermined dough shape about the cooking member. Alternatively, the cooking member may be inserted or pressed into a lump of the dough.

According to U.S. Pat. No. 5,807,599, the cooking member is an elongate member made of a flexible material such as silicone. In that case, the elongate member may be bent to assume a desired form such as a circle. The dough generally conforms to the bent cooking member. The dough has a toroidal shape when the cooking member is bent into a circle.

As disclosed in U.S. Pat. No. 5,807,599, an end of the elongate member is left protruding from the uncooked dough form. After the dough is cooked, the elongate member is removed from the dough by grasping the protruding end of the elongate member and pulling the elongate member from the cooked dough. An edible filling may be injected or otherwise deposited into the chamber of the hollow dough cooked product after the pulling of the elongate member from the cooked dough.

U.S. Pat. No. 6,165,527 describes a machine for manufacturing hollow toroidal food products such as bagels utilizing cooking members or inserts as described more generally in U.S. Pat. No. 5,807,599. While the machine U.S. Pat. No. 6,165,527 is operative, it require optimization for commercial purposes.

### OBJECTS OF THE INVENTION

An object of the present invention is to provide a method for producing a cooked food product having an internal chamber for receiving an edible composition.

Another object of the present invention is to provide a machine or apparatus for cooking or baking a food product so that the food product has a hollow interior for receiving an edible composition.

It is an additional object of the present invention to provide such a machine or apparatus that is suitable for producing a hollow bagel.

A further object of the present invention is to provide such a machine or apparatus that produces a food product which is provided with a filling.

It is a related object of the present invention to provide a method for shaping a dough preform and for cooking or baking the preform to generate a food product having a hollow interior.

Another associated object of the present invention is to provide such a method that is applicable to a bagel.

A supplemental object of the present invention is to provide a method of manufacturing a food product that is provided with a filling.

These and other objects of the present invention will be apparent from the descriptions and illustrations herein. While it is true that each object of the invention is attained in at least one embodiment of the invention, there is not necessarily any one embodiment that achieves all of the objects.

### SUMMARY OF THE INVENTION

A method for manufacturing a food product comprises, in accordance with the present invention, forming a closed dough preform having an arcuate portion that is at least partially hollow and cooking the dough preform to form a cooked comestible item having an internal chamber in the arcuate portion. The word “closed” is intended to signify that the preform has an internal space that is closed off from communication with the ambient atmosphere. Thus, the preform has no openings or holes in an external surface that communicate with the internal space or hollow interior of the preform.

In a preferable utilization of the invention, the dough preform is substantially toroidal and has a circumferential extent. The preform is hollow along at least a portion of the circumferential extent. More preferably, the dough preform is hollow substantially throughout the circumferential extent. The comestible item may be a hollow bagel.

Pursuant to further features of the present invention, the forming of the dough preform includes providing a flat sheet of dough, cutting the sheet into strips, rolling the strips into cylindrical configurations, sealing the cylindrical configurations along joints and ends thereof to form a plurality of elongate dough rods each being at least partially hollow, and bending the dough rods to generate the arcuate portions. Where the dough preforms are toroidal as in the case of bagel manufacture, the dough rods are bent into generally circular shapes, and opposite ends of each of the dough rods are joined to one another to form the dough preforms.

Where any given dough preform has an internal space that is transformed into the chamber of the respective comestible item during the cooking of the dough preform, the method further comprises maintaining the internal space intact, i.e., in an uncollapsed configuration, prior to and during cooking of the dough preform. The maintaining of the internal space may be accomplished by injecting a gaseous composition (such as air) into the internal space of the given preform prior to the cooking thereof. The injecting of the gaseous composition may in turn be implemented by inserting a distal end portion of a hollow needle through the dough of the preform and forcing the gaseous composition through the needle.

Where the manufacturing process is to produce items such as bagels, the cooking of the preforms includes baking the preforms. Optionally, the process may include boiling the preforms prior to the baking process.

The manufacturing method may additionally comprise the steps of puncturing the cooked comestible items and injecting an edible filling into the internal chambers thereof.

An apparatus for manufacturing a food product comprises an assembly line including dough shaping tools for forming closed dough preforms each having an arcuate portion that is at least partially hollow. The apparatus additionally comprises at least one heating device for cooking the dough preforms to form cooked comestible items each having an internal chamber in the respective arcuate portion. The apparatus further comprises a transport mechanism such as a conveyor for moving the dough preforms from the assembly line to the heating device.

Pursuant to another feature of the present invention, the shaping tools include at least one press or roller for generating a flat sheet of dough, at least one cutter for severing the sheet into strips, shaping members for curving the strips into cylindrical configurations, at least one first closure device for sealing the cylindrical configurations along joints and ends thereof to form a plurality of elongate dough rods each being at least partially hollow, and bending elements engageable with the dough rods for deforming the dough rods to generate the arcuate portions.

Where the food items produced by the apparatus are toroidal such as bagels, the bending elements are engageable with the dough rods for forming the dough rods into generally circular shapes. In addition, the apparatus includes at least one second closure device for joining the opposite ends of each of the dough rods to one another to form the dough preforms.

Where the dough preforms have internal spaces that are transformed into the internal chambers during the cooking of the dough preforms, the apparatus further comprising means such as a gas injector for maintaining the internal spaces intact or uncollapsed prior to and during cooking of the dough preforms. The injector may include a hollow needle insertable through the dough of the preforms and a pressurization component (such as a pump or a pressurized air tank with an air-flow control valve) connected to the needle for forcing the gaseous composition through the needle.

### BRIEF DESCRIPTION OF THE DRAWING

FIG. 1 is a diagram of an assembly-line apparatus or system for manufacturing hollow food items such as bagels.

FIG. 2 is a top plan view of a bagel with an internal chamber, produced by the apparatus or system of FIG. 1.

FIG. 3 is a schematic side elevational view of a portion of a bagel manufacturing assembly line in accordance with the present invention.

FIGS. 4-11 are schematic diagrams showing successive steps in a bagel manufacturing assembly-line process related to that shown in FIG. 1.

FIG. 12 is a schematic broken-away perspective view of an extruder used in a modified bagel-manufacturing apparatus or system.

FIG. 13 is a schematic cross-sectional view of a modified form of the extruder shown in FIG. 12.

FIG. 14 is a schematic top view of a dough support and bagel-preform shaping device utilizable in association with the extruders of FIGS. 12 and 13.

FIG. 15 is a schematic cross-sectional view taken along line XV-XV in FIG. 14.

### DETAILED DESCRIPTION

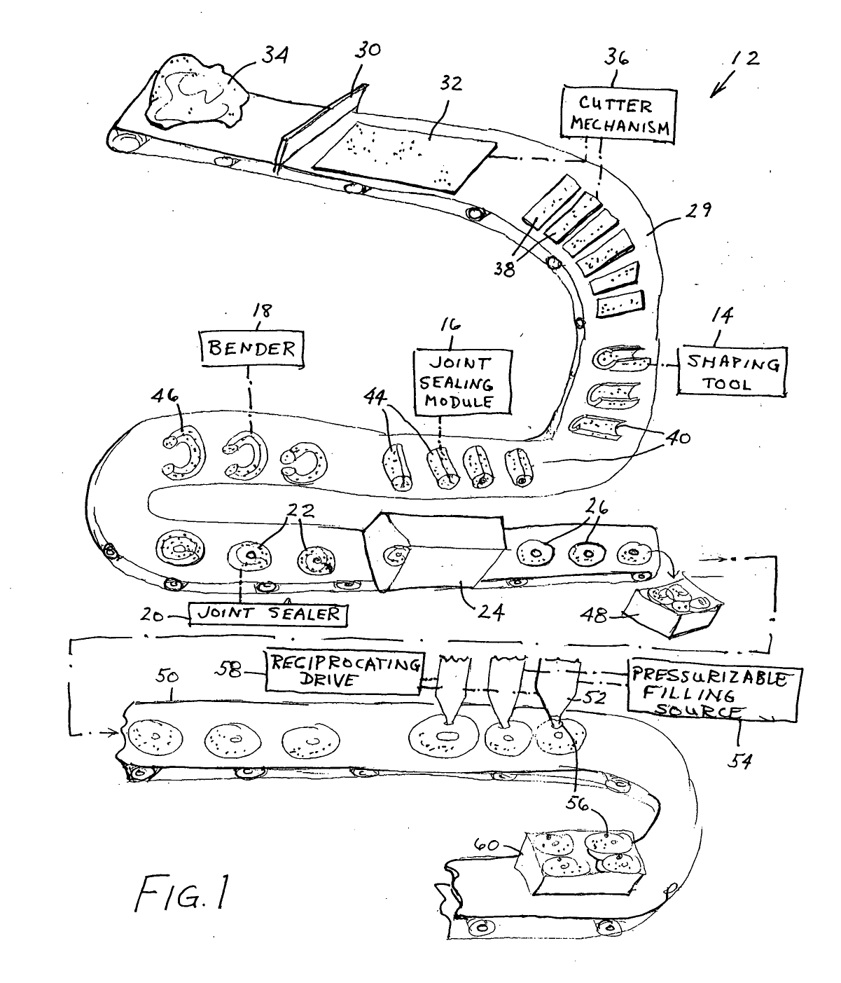

As illustrated in FIG. 1, an apparatus for manufacturing a toroidal food product such as a bagel comprises an assembly line 12 including dough shaping tools 14, 16, 18, and 20 for forming closed toroidal dough preforms 22. Preforms 22 are hollow and annular or, alternatively worded, arcuate along their entire circumferential extents. Each preform 22 includes an internal space that preferably extends substantially through the entire circumferential extent of the preform.

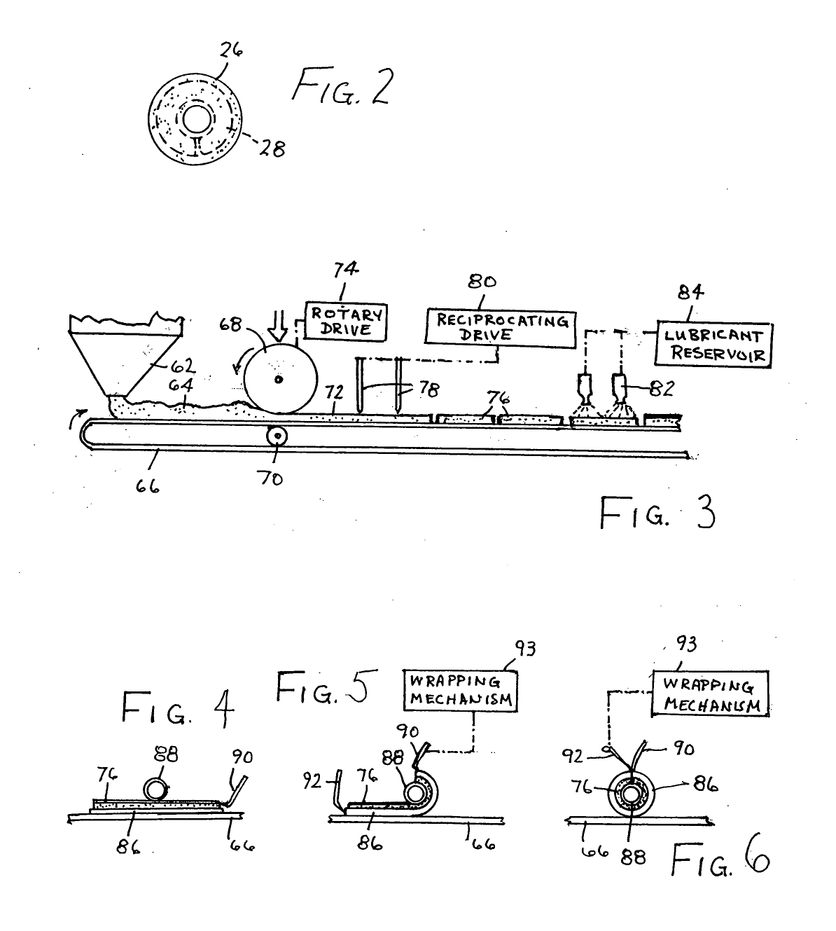

The apparatus of FIG. 1 additionally comprises at least one heating device 24 exemplarily in the form of a baking oven for cooking the dough preforms 22 to form cooked comestible items 26 each having at least one internal chamber 28 (FIG. 2) in an arcuate portion of the respective item. The apparatus further comprises a transport mechanism such as a belt conveyor 29 for moving the dough preforms 22 from the assembly line 12 to the heating device 24.

The shaping tools of the assembly line 12 may include at least one roller or press 30 such as an extrusion or leveling plate for generating a flat dough sheet 32 from a lump of dough 34. The shaping tools may additionally at least one cutter 36 for severing the dough sheet 32 into strips 38.

Shaping members or tools 14 serve to curve or roll the dough strips 38 into cylindrical configurations 40. Dough shaping tools 16 include at least one closure or joint sealing device for sealing the dough cylinders 40 along longitudinal joints and optionally for closing the ends 42 of the dough cylinders to form a plurality of elongate dough rods 44 each being at least partially hollow, preferably along their entire longitudinal extent. Shaping tools 18 are bending elements engageable with the dough rods 44 for deforming the dough rods into arcuate configurations 46. Where the food items produced by the apparatus of FIG. 1 are toroidal such as bagels, the bending elements 18 are engageable with the dough rods 44 for forming the dough rods into generally circular shapes 46. Shaping tools 20 include at least one closure or dough sealing device for joining the opposite ends 42 of the annularly configured dough rods 46 to one another to form the dough preforms 22.

As shown in FIG. 1, the cooked comestible items 26 may be packaged as indicated at 48 or transported via a conveyor 50 to a filling station where one or more injectors 52 are disposed for introducing a preselected filling composition from a pressurizable reservoir 54 into the internal spaces or chambers 28 (FIG. 2) of the food items 26. Injectors 52 may take the form of nozzles or hollow needles with sharp free ends for facilitating penetration through the cooked farinaceous material of items 26. Alternatively, additional piercing or drilling tools (not shown) may be provided upstream of the injectors 52 for forming holes 56 in the cooked food items 26. Appropriate machinery, well known in the art, exemplarily including a reciprocating drive 58, is provided for enabling the synchronized engagement of the piercing or drilling tools and the injectors 52 with the cooked food items 26. Downstream of injectors 52, the filled food items 26 are loaded into cartons 60 for transport and delivery.

As depicted in FIG. 3, a bagel manufacturing assembly line includes a hopper 62 continuously dispensing a load of dough 64 onto a conveyor belt 66. Belt 66 transports the deposited dough 64 to a pair of rollers 68 and 70 that press the dough into a flattened sheet 72. At least one of the rollers 68 is rotated by a rotary drive 74. The dough sheet 72 is cut into strips 76 by a plurality of cutting blades 78 operated by a reciprocating drive 80. Downstream of the cutting blades 78, dough strips 76 are sprayed at least along their upper surfaces with a comestible lubricant composition such as vegetable oil. To that end, a plurality of spray nozzles 82 is disposed along conveyor belt 66 and supplied with lubricant from a reservoir 84. Downstream (or upstream) of nozzles 82, the lubricated dough strips 76 are positioned on flexible mats 86, as shown in FIG. 4. After the deposition of a dough strip 76 onto a respective mat 86 and after the lubricating of the strip by nozzles 82, a cylindrical shaping mandrel 88 is placed into contact with the lubricated upper surface of the dough strip, as shown in FIG. 4. As shown in FIGS. 4 and 5, one or more entrainment hooks 90 catch a forward end of the mat 86 and, under the operation of a wrapping mechanism 93, loop the mat together with the respective dough strip 76 around a half of the shaping mandrel 88 (FIG. 5). Another set of entrainment hooks 92 (FIGS. 5 and 6) may be used to wrap the trailing end portion of the mat 86 and the dough strip 76 about the other half of the shaping mandrel 88.

Subsequently, as illustrated in FIG. 7, ancillary holding members 94 such as plates or rollers maintain the mat 86 and dough strip 76 in a wrapped configuration about the respective mandrel 88, while a longitudinal seam or joint in the curled dough strip 76 is exposed. A sealing tool 96 in the form of an arcuate plate is placed into engagement with the curled dough strip and supplied with one or more forms of energy, for instance, mechanical vibratory energy from a vibration source 98, and possibly heat or electrical energy, for purposes of sealing the dough along the longitudinal seam of joint to form a cylindrical dough preform 100.

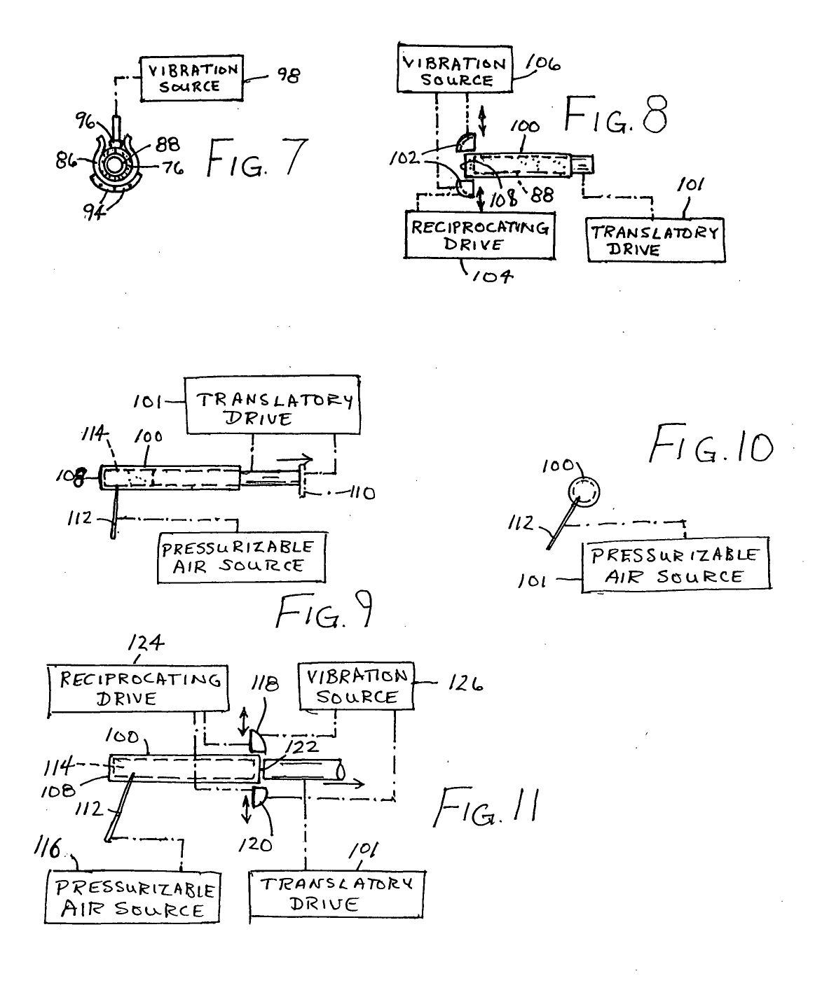

After the sealing of the longitudinal joint, the mandrel 88 is partially withdrawn from the dough preform 100 by a translatory drive 101, as illustrated in FIG. 8. Then one or more end closure elements 102 are moved by a reciprocating drive 104 into engagement with one end 108 of the cylindrical dough preform 100 to close off that end of the preform. Mechanical vibratory energy from a vibration source 106, and optionally other forms of energy, is supplied to the closed dough end 108 via the closure elements 102 to seal the dough.

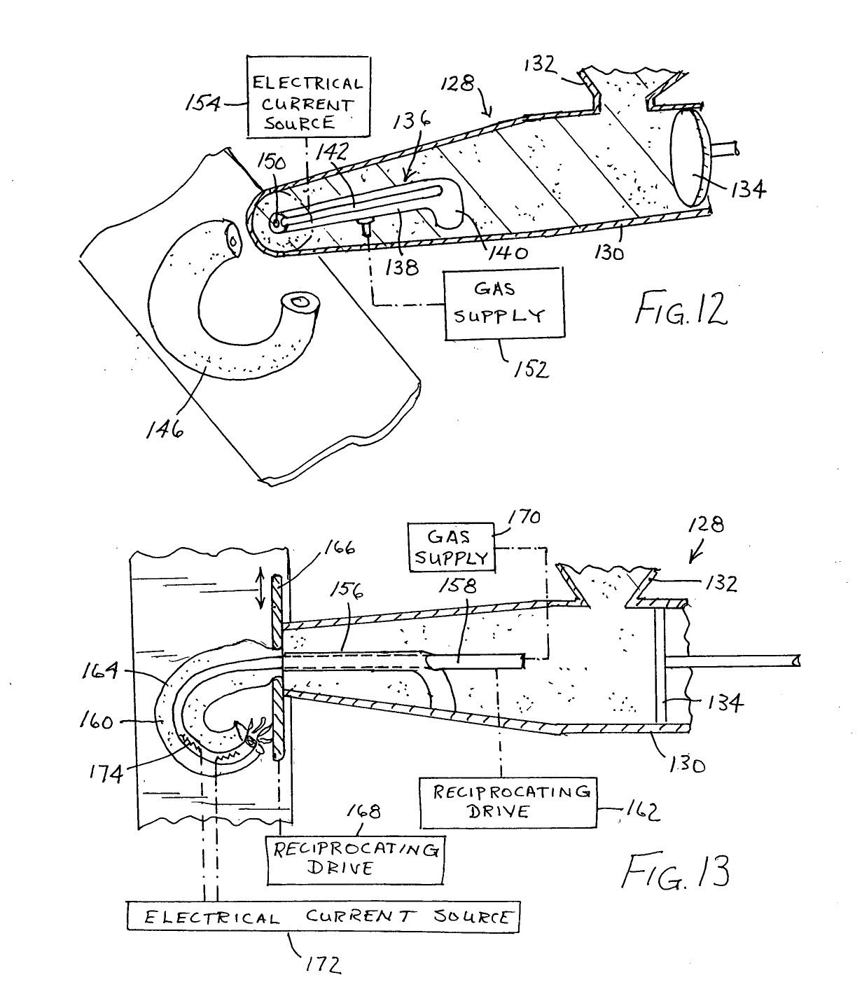

After the sealing of the end 108 of dough preform 100, the cylindrical mandrel 88 may be sealed or plugged, for instance by an end plate 110, while a fine-gauge hypodermic needle 112 is inserted into the preform so as to communicate with an internal cavity or space 114 therein, as illustrated in FIG. 9. During continued withdrawal of the sealed mandrel 88 from the dough preform 100 under the action of translatory drive 101, air from a pressurizable but low-pressure source 116 is injected into the internal cavity 114 of the preform 100 via needle 112. As shown in FIG. 10, the needle 112 is preferably inserted at a lower side of the dough preform 100 to facilitate the natural closing, upon a subsequent withdrawal of the needle, of the perforation made by the needle. The pressure of the air delivered to the internal cavity 112 of the preform 100 is generally at atmospheric pressure or slightly greater than atmospheric pressure in order to prevent the dough preform from collapsing and thereby maintain the internal cavity intact in an uncollapsed or expanded configuration.

As depicted in FIG. 10, immediately upon a withdrawal of the mandrel 88, two closure members 118 and 120 move to close the open end 122 of dough preform 100 under the action of a reciprocating drive 124. Vibratory energy from a vibration source 126 is applied to the end 122 of the dough preform via the closure members 118 and 120. During the withdrawal of mandrel 88 from dough preform 100, a conical insert (not shown) may be introduced into mandrel for purposes of sealing the mandrel and cooperating with closure members 118 and 120 during a closure stroke thereof to ensure a practically effective continued seal at dough end 122 during the closure and sealing thereof. The conical member is retracted through mandrel 188 while the closure members 118 and 120 approach one another.

During a subsequent curving of dough preform 100 to form an annular configuration as indicated at 46 and 22 in FIG. 1, needle 112 may remain embedded in the preform to enable injection of a higher pressure into the dough for purposes of maintaining the cylindrical cross-section of the internal cavity during the shaping of the dough into the annular form.

The bender tool 18 of FIG. 1 may include a sling that may be formed into an annular shape.

It is possible to form the dough rods 44 of FIG. 1 by means of an extruder similar to the extruder 128 shown in FIG. 12. Extruder 128 includes a casing 130 provided at one end with a hopper 132 and a pressurization member 134 such as a screw or plunger and at an opposite end with a mandrel 136 extending generally parallel to an extrusion axis. Mandrel 136 has an elongate main section 138 that is secured to an inner surface of casing 130 via a leg section 140. As illustrated in FIG. 12, mandrel 136 may be provided along one side with a groove 142 that causes a cylinder of extruded dough 44 to curl into an arcuate configuration 146 like that of configurations 46 in FIG. 1. The extruded dough 144 is deposited on a conveyor belt 148.

As further depicted in FIG. 12, mandrel 136 may be provided with a lumen 150 for the conduction of a flammable gas mixture from a supply, tank, or reservoir 152. The gas may be ignited at a free end of mandrel 136 during an extrusion operation for purposes of hardening an inner surface of the extruded dough, thereby provided the extrusion with internal support. Alternatively or additionally, the gas from supply 152 may be used to provide an internal pressure to the extruded dough forms, as discussed above.

Hardening of the inner surface of the extruded dough 144 may be alternatively or additionally accomplished by heating mandrel 136, for instance, by means of an electrical current conducted from a source 154. Alternatively, section 138 of mandrel 136 may be heated via a hot liquid circulated from a heat exchanger (not shown) or a magnetic field.

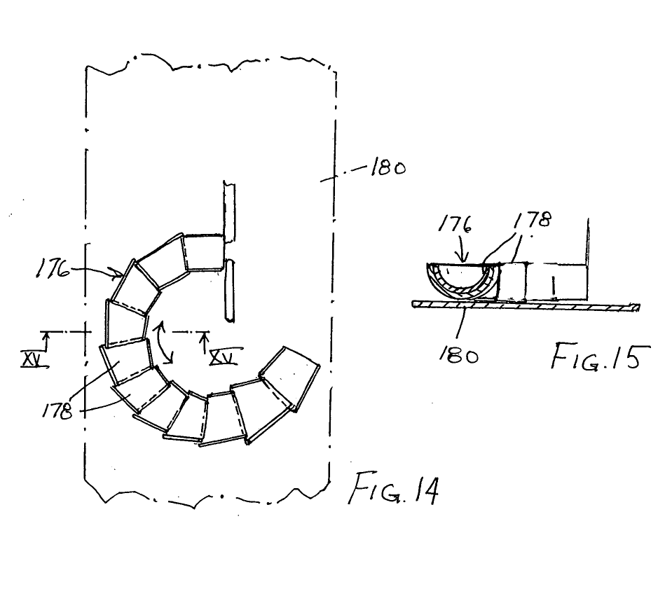

FIG. 13 shows an extruder mandrel 156 that is longitudinally traversed by an elongate member 158 having a flexible free end 160 that is preformed to assume a curled configuration. Elongate member 158 is reciprocated with respect to mandrel 156 by a drive 162 so that free end 160 is alternately extended from and retracted into the mandrel. Elongate member 158 is moved to extend end section 160 during dough extrusion by the extruder 128. Upon the completion of extrusion of a single bagel preform 164, drive 162 moves the elongate member so as to retract the end section 160 into mandrel 156. One or more gates 166 shiftable in a programmed sequence by a reciprocating drive 168 may be provided at the extruder mouth 168 for severing the dough optionally closing off the trailing end of the extruded dough perform 164, simultaneously formed a closed leading end of the next dough perform to be extruded.

Elongate member 158 may be provided with a channel or duct (not shown) for conveying a gas from a supply, tank or reservoir 170. The gas may be a flammable composition ignited at a free end of elongate member 158 during a withdrawal of the elongate member from the extruded dough preform 164 for purposes of hardening an inner surface of the extruded dough, thereby provided the extrusion with internal support. Alternatively or additionally, the gas from supply 170 may be used to provide an internal pressure to the extruded dough preform 164, as discussed above. Hardening of the inner surface of the extruded dough 164 may be alternatively or additionally accomplished by heating member 158, for instance, by means of an electrical current conducted from a source 172 to heating elements 174 mounted to or embedded in member 158.

As depicted in FIGS. 14 and 15, a dough preform bending mechanism 176 disposable, for instance, at the mouth of extruder 128 and immediately above a conveyor belt 180 a includes a series of overlapping or telescoping half-shells 178 that are constrained to assume a circular configuration as shown in FIG. 14 upon an extension stroke of the bending mechanism. The alternating extension and retraction strokes may be effectuated in any known manner, by gearing, camming mechanisms, an extensible member similar to member 158 with an arcuate rest configuration, etc.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for manufacturing a food product, comprising:
forming a closed dough preform having an arcuate portion that is at least partially hollow; and
cooking said dough preform to form a cooked comestible item having an internal chamber in said arcuate portion.

2. The method defined in claim 1 wherein said dough preform is substantially toroidal and has a circumferential extent, said preform being hollow along at least a portion of said circumferential extent.

3. The method defined in claim 2 wherein said dough preform is hollow substantially throughout said circumferential extent.

4. The method defined in claim 3 wherein the forming of said dough preform includes:
providing a flat sheet of dough;
cutting said sheet into strips;
rolling said strips into cylindrical configurations;
sealing said cylindrical configurations along joints and ends thereof to form a plurality of elongate hollow dough rods each having opposite ends;
bending said dough rods into generally circular shapes; and
joining the opposite ends of each of said dough rods to one another to form said dough preforms.

5. The method defined in claim 1 wherein said dough preform has an internal space that is transformed into said chamber during the cooking of said dough preform, further comprising maintaining said internal space intact or uncollapsed prior to and during cooking of said dough preform.

6. The method defined in claim 5 wherein the maintaining of said internal space includes injecting a gaseous composition into said space prior to the cooking of said dough preform.

7. The method defined in claim 6 wherein the injecting of said gaseous composition includes inserting a distal end portion of a hollow needle through the dough of said preform and forcing said gaseous composition through said needle.

8. The method defined in claim 7 wherein said gaseous composition is air.

9. The method defined in claim 1 wherein the forming of said dough preform includes:
providing a flat sheet of dough;
cutting said sheet into strips;
rolling said strips into cylindrical configurations;
sealing said cylindrical configurations along joints and ends thereof to form a plurality of elongate dough rods each being at least partially hollow; and
bending said dough rods to generate said arcuate portions.

10. The method defined in claim 1 wherein the cooking of said preform includes baking said preform.

11. The method defined in claim 1, further comprising puncturing the cooked comestible item and injecting an edible filling into said internal chamber.

12. The method defined in claim 1, further comprising feeding a gaseous composition to said internal chamber at least prior to the cooking of said dough preform.

13. An apparatus for manufacturing a food product, comprising:
an assembly line including dough shaping tools for forming closed dough preforms each having an arcuate portion that is at least partially hollow;
at least one heating device for cooking said dough preforms to form cooked comestible items each having an internal chamber in the respective arcuate portion; and
a transporter for conveying the dough preforms from said assembly line to said heating device.

14. The apparatus defined in claim 13 wherein said shaping tools include:
at least one press or roller for generating a flat sheet of dough;
at least one cutter for severing said sheet into strips;
shaping members for curving said strips into cylindrical configurations;
at least one first closure device for sealing said cylindrical configurations along joints and ends thereof to form a plurality of elongate hollow dough rods each having opposite ends;
bending elements engageable with said dough rods for forming said dough rods into generally circular shapes; and
at least one second closure device for joining the opposite ends of each of said dough rods to one another to form said dough preforms.

15. The apparatus defined in claim 14 wherein said dough preforms have internal spaces that are transformed into said internal chambers during the cooking of said dough preforms, further comprising means for maintaining said internal spaces intact or uncollapsed prior to and during cooking of said dough preforms.

16. The apparatus defined in claim 15 wherein said means for maintaining said internal spaces includes at least one injector for introducing a gaseous composition into said spaces prior to the cooking of said dough preforms.

17. The apparatus defined in claim 16 wherein said injector includes a hollow needle insertable through the dough of said preforms and pressurization component connected to said needle for forcing said gaseous composition through said needle.

18. The apparatus defined in claim 13 wherein the forming of said dough preform includes:
at least one press or roller for generating a flat sheet of dough;
at least one cutter for severing said sheet into strips;
shaping members for curving said strips into cylindrical configurations;
at least one first closure device for sealing said cylindrical configurations along joints and ends thereof to form a plurality of elongate dough rods each being at least partially hollow; and
bending elements engageable with said dough rods for deforming said dough rods to generate said arcuate portions.

19. The apparatus defined in claim 13, further comprising means puncturing the cooked comestible items and injecting edible filling into the respective internal chambers.

20. The apparatus defined in claim 13, further comprising means for feeding a gaseous composition to said internal chambers at least prior to the cooking of said dough preforms.

21. The apparatus defined in claim 13 wherein said heating device is taken from the grouping consisting of an oven and a hot bath.
